(19) United States
(12) Patent Application Publication
(10) Pub. No.: US 2021/0001883 A1
(43) Pub. Date: Jan. 7, 2021

(54) ACTION SELECTION DEVICE, COMPUTER READABLE MEDIUM, AND ACTION SELECTION METHOD

(71) Applicant: MITSUBISHI ELECTRIC CORPORATION, Tokyo (JP)

(72) Inventors: Takafumi KASUGA, Tokyo (JP); Masahiko TANIMOTO, Tokyo (JP); Takayuki SAWAMI, Tokyo (JP); Yosuke ISHIWATARI, Tokyo (JP)

(73) Assignee: MITSUBISHI ELECTRIC CORPORATION, Tokyo (JP)

(21) Appl. No.: 17/030,005

(22) Filed: Sep. 23, 2020

Related U.S. Application Data
(63) Continuation of application No. PCT/JP2018/016560, filed on Apr. 24, 2018.

(51) Int. Cl. B60W 60/00; G06K 9/00; G06K 9/20; B60W 40/02; B60W 40/10

(52) U.S. Cl. CPC B60W 60/0011; G06K 9/00805; G06K 9/2054; B60W 2050/0215; B60W 40/10; B60W 2554/40; B60W 2420/42; B60W 40/02

(57) ABSTRACT

An action selection device (10) includes an action selection unit (22). The action selection unit (22) acquires from a memory (30), an action list (31) in which a requirement recognition area is associated with each action of a plurality of actions, the requirement recognition area indicating an area for which recognition by a sensor is required. The action selection unit (22) acquires from a peripheral recognition device (53), a recognition area (53a) recognized by sensors (53-1) that the peripheral recognition device (53) has. The action selection unit (22) selects from the action list (31), an action associated with the requirement recognition area included in the recognition area (53a).

### CROSS REFERENCE TO RELATED APPLICATIONS

This application is a Continuation of PCT International Application No. PCT/JP2018/016560, filed on Apr. 24, 2018, which is hereby expressly incorporated by reference into the present application.

### TECHNICAL FIELD

The present invention relates to an action selection device, an action selection program, and an action selection method for selecting an action of an autonomous operation apparatus represented by an autonomous operation vehicle.

### BACKGROUND ART

Advanced driving support systems such as a lane departure warning system (LDW), a pedestrian detection system (PD), and an adaptive cruise control system (ACC) have been developed for purposes of driving support and preventive safety for drivers. In addition, an autonomous operation system has been developed, which drives a part or all of a way to a destination in place of a driver.

In general, autonomous operation is implemented by three processes that are a recognition process of a peripheral condition of an autonomous operation vehicle, a determination process of a next action of the autonomous operation vehicle, and an operation process of accelerating, braking, and steering of the autonomous operation vehicle.

Regarding the above-described determination process, Patent Literature 1 discloses a track generation device described below. The track generation device includes an acquisition mean for acquiring a travel obstruction area. With the track generation device, in a process of generating a travel track from a current location to a target travel location, the acquisition mean acquires the travel obstruction area that obstructs traveling of a vehicle, and the track generation device calculates the travel track that avoids the travel obstruction area.

The acquisition mean determines the travel obstruction area based on location information of the vehicle acquired from a GPS receiver, obstruction information which is an analysis result of data measured by sensors such as a millimeter wave radar and a camera, and road map information near the current location of the vehicle. As a result, in Patent Literature 1, the autonomous operation that does not cause a collision with an obstruction is realized.

### CITATION LIST

### Patent Literature

Patent Literature 1: JP2008-149855A

### SUMMARY OF INVENTION

### Technical Problem

In obstruction detection by the sensor mounted on the autonomous operation vehicle, depending on a factor such as local weather in which the autonomous vehicle is traveling, a driving environment such as a road on which the autonomous vehicle is traveling, travel speed of the autonomous vehicle or sensor malfunction, a detection area of the obstruction by the sensor and detection accuracy of the sensor dynamically change.

However, in Patent Literature 1, it is not considered that the detection area of the obstruction by the sensor and the detection accuracy of the sensor dynamically change. Therefore, for an area where the sensor has not been able to confirm a presence of the obstruction, a device of Patent Literature 1 has a possibility to incorrectly recognize that the obstruction does not exist, and generate the travel track.

The present invention aims to provide an action selection device that causes an autonomous operation apparatus that autonomously drives to take an action corresponding to a dynamic change even when a detection area of an obstruction by a sensor or detection accuracy of the sensor dynamically changes.

### Solution to Problem

An action selection device according to the present invention includes:

an action group information acquisition unit to acquire action group information in which a requirement recognition area is associated with each action of a plurality of actions, the requirement recognition area indicating an area for which recognition by a sensor is required; and

a selection unit to acquire a sensor recognition area indicating an area recognized by the sensor, and select from the action group information, an action associated with the requirement recognition area included in the sensor recognition area.

### Advantageous Effects of Invention

An action selection device of the present invention includes a selection unit. Therefore, even if a recognition area recognized by a sensor dynamically changes due to a factor such as weather or a time range, with the selection unit, it is possible to select an appropriate action for autonomous operation.

### BRIEF DESCRIPTION OF DRAWINGS

FIG. 1 is a diagram explaining changes in detection ranges detected by sensors, which is a diagram according to a first embodiment;

FIG. 2 is a hardware configuration diagram of an action selection device 10, which is the diagram according to the first embodiment;

FIG. 3 is a flowchart illustrating operation of the action selection device 10, which is the diagram according to the first embodiment;

FIG. 4 is a sequence diagram illustrating the operation of the action selection device 10, which is the diagram according to the first embodiment;

FIG. 5 is a diagram illustrating an action list 31, which is the diagram according to the first embodiment;

FIG. 6 is a diagram illustrating a specific example of the action list 31, which is the diagram according to the first embodiment;

FIG. 7 is a diagram illustrating a permission list 220, which is the diagram according to the first embodiment;

FIG. 8 is a diagram explaining a method for dividing a peripheral area of an automobile 70, which is the diagram according to the first embodiment;

FIG. 9 is a diagram explaining environment correction information 32, which is the diagram according to the first embodiment;

FIG. 10 is a diagram explaining environment correction information 32-1, which is the diagram according to the first embodiment; and

FIG. 11 is a diagram explaining evacuation condition information 33, which is the diagram according to the first embodiment.

### DESCRIPTION OF EMBODIMENTS

### First Embodiment

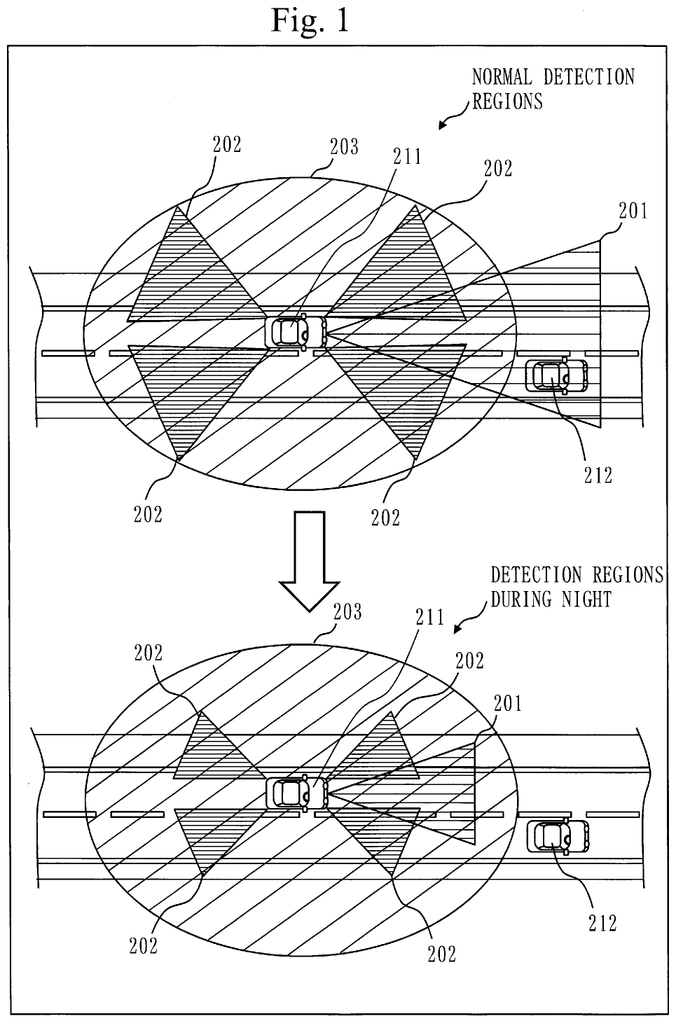

FIG. 1 illustrates an example in which detection areas detected by sensors such as a camera and a lidar fluctuate. The detection areas are decreased during night as compared to a normal time such as daytime when the weather is good.

FIG. 1 illustrates a detection range 201 of a front camera being a first camera, detection ranges 202 of second cameras, and a detection range 203 of the lidar. FIG. 1 illustrates that the detection range 201 of the front camera and the detection ranges 202 of the second cameras are narrower during night than in the normal time. Besides, the detection range 203 of the lidar during night is the same as that in the normal time. In the normal time, an automobile 211 is able to detect a preceding vehicle 212 which is an obstruction traveling in right front of the automobile 211. However, with the front camera, the automobile 211 is not able to detect the preceding vehicle 212 during night because the preceding vehicle 212 is outside the detection area of the automobile 211.

Even when the detection areas dynamically change as illustrated in FIG. 1, an action selection device 10 according to the first embodiment can cause an autonomous operation vehicle to take an action corresponding to changes.

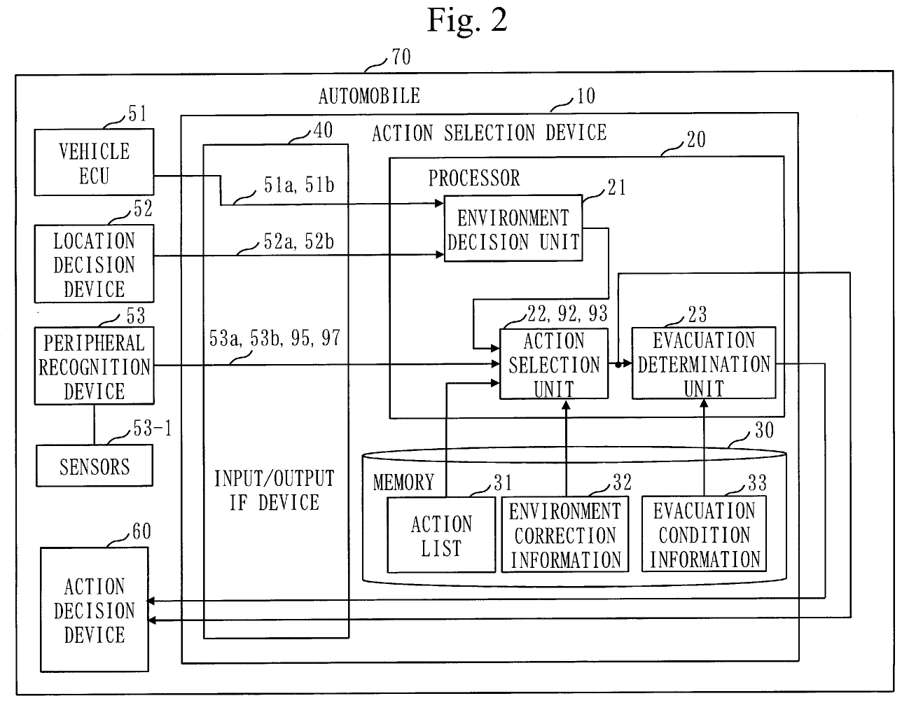

A first embodiment will be described with reference to FIGS. 2 to 11.

*** Description of Configuration ***

FIG. 2 illustrates a hardware configuration of the action selection device 10. FIG. 2 illustrates a state in which the action selection device 10 is mounted on a moving body 70. The moving body 70 is an apparatus capable of performing movement as well as performing autonomous operation for the movement. The moving body 70 is a moving body such as a vehicle, a ship, or a robot. In the first embodiment, the moving body 70 is assumed to be an autonomous operation vehicle. Hereinafter, the autonomous operation vehicle that is the moving body 70 is referred to as an automobile 70 bellow.

The action selection device 10 is a computer mounted on the automobile 70. The action selection device 10 includes as hardware, a processor 20, a memory 30, and an input/output interface device 40. The input/output interface device 40 is hereinafter referred to as an input/output IF device 40. The processor 20 is connected to other hardware via a system bus and controls these pieces of other hardware. The processor 20 is a processing circuitry.

The processor 20 is an IC (Integrated Circuit) that performs processing. Specific examples of the processor 20 are a CPU (Central Processing Unit), a DSP (Digital Signal Processor), a GPU (Graphics Processing Unit), and an FPGA (Field Programmable Gate Array).

The processor 20 has the CPU, the DSP, the GPU, and the FPGA. In the processor 20, a function of the action selection device 10 is implemented by executing a program by the CPU, the DSP, the GPU, and the FPGA in cooperation with each other.

The CPU performs processes such as program execution and data operation. The DSP performs digital signal processes such as an arithmetic operation and data movement. For example, a process such as sensing of sensor data obtained from a millimeter wave radar is preferably not processed by the CPU but processed at high speed by the DSP.

The GPU is a processor specialized for an image process. The GPU can perform the image process at high speed by processing in parallel, a plurality of pieces of pixel data. The GPU can process at high speed, a template matching process frequently used in the image process. For example, sensing of the sensor data obtained from the camera is preferably processed by the GPU. If the sensing of the sensor data obtained from the camera is processed by the CPU, a process time becomes enormous. Further, in addition to a usage as a mere processor for the image process, the GPU may also be used for performing general purpose computing by using an operation resource of the GPU (GPGPU: General Purpose Computing on Graphics Processing Units). Although with conventional image process technology, there is a limit in detection accuracy to detect a vehicle shown in an image, it is possible to detect the vehicle with higher accuracy by performing the image process with deep learning by GPGPU.

The FPGA is a processor in which a configuration of a logic circuit can be programmed. The FPGA has properties of both a dedicated hardware operation circuit and programmable software. Process with a complex operation and parallelism can be executed at high speed with the FPGA.

The memory 30 includes a non-volatile memory and a volatile memory. The non-volatile memory can keep an execution program and data even when power of the action selection device 10 is off. The volatile memory is able to move the data at high speed during operation of the action selection device 10. Specific examples of the non-volatile memory are an HDD (Hard Disk Drive), an SSD (Solid State Drive), and a flash memory. Specific examples of the volatile memory are DDR2-SDRAM (Double-Data-Rate2 Synchronous Dynamic Random Access Memory), and a DDR3-SDRAM (Double-Data-Rate3 Synchronous Dynamic Random Access Memory). The non-volatile memory may be a portable storage medium such as an SD (Secure Digital) memory card, a CF (CompactFlash), a NAND flash, a flexible disk, an optical disk, a compact disk, a Blu-ray (registered trademark) disk, or a DVD. The memory 30 is connected to the processor 20 via a memory interface which is not illustrated. The memory interface is a device that unitarily manages memory access from the processor 20 and performs efficient memory access control. The memory interface is used for processes such as data transfer in the action selection device 10 and writing on the memory 30, sensor data obtained from a peripheral recognition device 53. Here, the sensor data is a recognition area 53a and recognition accuracy 53b described later.

The action selection device 10 includes as functional components, an environment decision unit 21, an action selection unit 22, and an evacuation determination unit 23.

Functions of the environment decision unit 21, the action selection unit 22, and the evacuation determination unit 23 are implemented by an action selection program or the logic circuit that is hardware. When the functions of the environment decision unit 21, the action selection unit 22, and the evacuation determination unit 23 are implemented by the action selection program, the action selection program is stored in the memory 30. When the functions of the environment decision unit 21, the action selection unit 22, and the evacuation determination unit 23 are implemented by the logic circuit, logic circuit information is stored in the memory 30. The action selection program or the logic circuit information is read and executed by the processor 20.

The action selection program is a program causing a computer to execute each process, each procedure or each step in which “unit” of each unit of the environment decision unit 21, the action selection unit 22, and the evacuation determination unit 23 is read as “process”, “procedure” or “step”. Also, an action selection method is a method implemented by executing the action selection program by the action selection device 10 that is the computer.

The action selection program may be provided by being stored in a computer-readable storage medium, or may be provided as a program product.

In FIG. 2, only one processor 20 is illustrated. However, the processor 20 may consist of a plurality of processors. The plurality of processors 20 may execute in cooperation, programs that implement each function of the environment decision unit 21, the action selection unit 22, and the evacuation determination unit 23.

In the memory 30, an action list 31, environment correction information 32, and evacuation condition information 33 are stored.

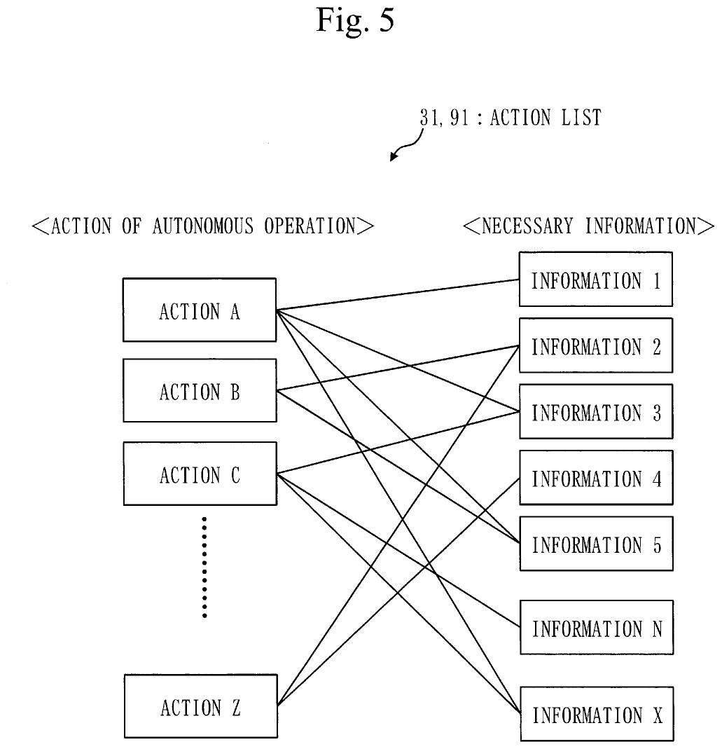

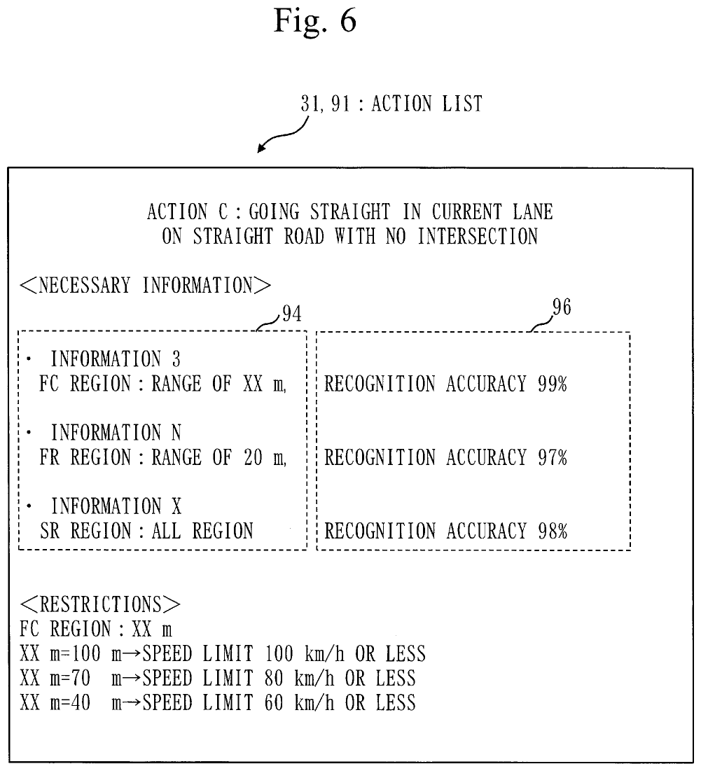

The action list 31 consists of a recognition area 31a and recognition accuracy 31b which are necessary for determining whether or not to be able to execute an individual action that may be executed in the autonomous operation. The action list 31 will be described later in explanations of FIGS. 5 and 6.

The environment correction information 32 has travel environment correction information that is correction information in an action selection process according to a road type. Also, the environment correction information 32 has external environment correction information that is correction information in an action selection process according to an external environment.

The road type is a type of a road such as a highway, a national road, or a community road.

The external environment is an environment such as weather, illuminance, a wind direction, or wind force.

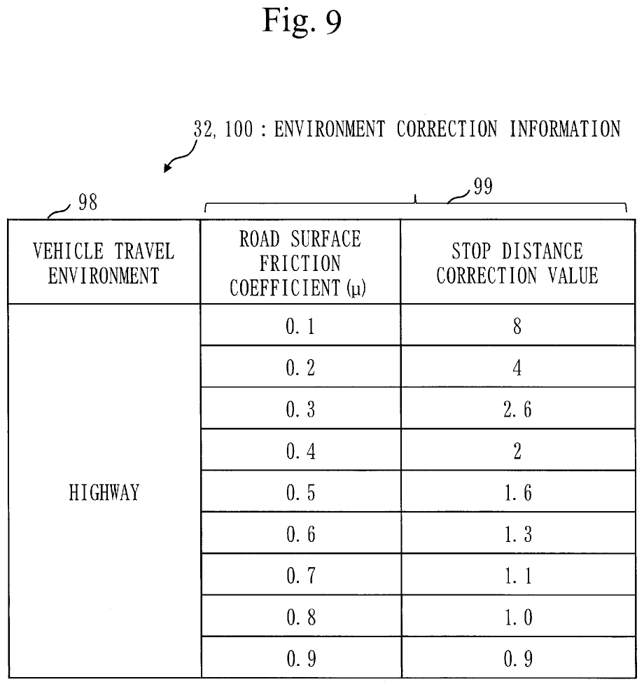

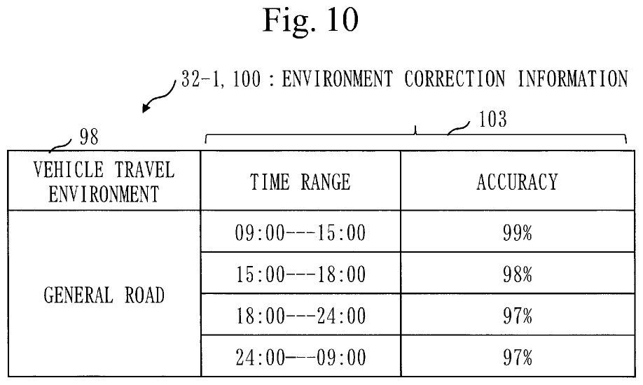

The environment correction information 32 will be described later in explanations of FIGS. 9 and 10.

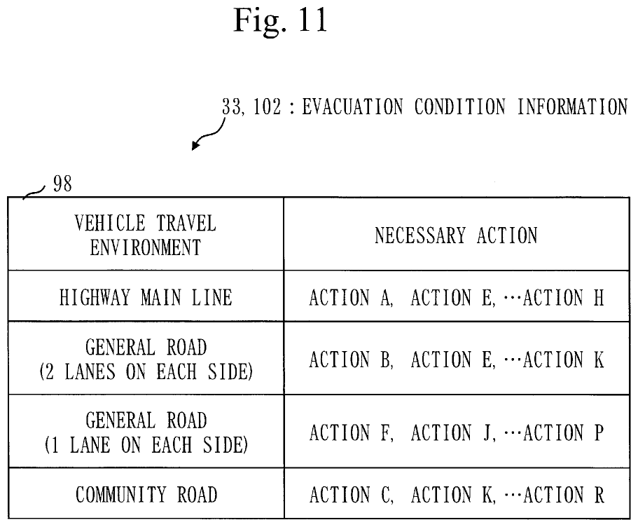

The evacuation condition information 33 is information that defines which is a minimum action required to be executed in order to continue the autonomous operation according to a travel environment 21a. The evacuation condition information 33 will be described later in explanations of FIG. 11.

The input/output IF device 40 is connected to a vehicle ECU (Electronic Control Unit) 51, a location decision device 52, the peripheral recognition device 53, and an action decision device 60 which are mounted on the automobile 70.

The vehicle ECU 51 operates speed of a vehicle and an operation angle of a steering wheel. The action selection device 10 acquires vehicle information 51a and external environment information 51b from the vehicle ECU 51. The vehicle information 51a is information such as the speed, a steering angle of the steering wheel, a stroke amount of an accelerator pedal, or a stroke amount of a brake pedal. The external environment information 51b is an environment of a place where the automobile 70 is located. Specifically, the external environment information 51b is information such as weather, illuminance, a wind direction, or wind speed.

The location decision device 52 calculates a location where the automobile 70 exists. The action selection device 10 acquires, from the location decision device 52, location information 52a of the automobile 70 and map information 52b on a periphery of the automobile 70 which is highly accurate and three-dimensional.

The peripheral recognition device 53 generates peripheral recognition information such as a location of an object on the periphery of the automobile 70 and an attribute of the object. The peripheral recognition device 53 is a computer having sensors 53-1 such as the camera, the lidar, and the millimeter wave radar. A hardware configuration includes a processor, a memory, and an input/output IF device in a similar way to the action selection device 10 in FIG. 2. The camera, the lidar, and the millimeter wave radar are connected to the input/output IF device. The action selection device 10 acquires the recognition area 53a and the recognition accuracy 53b from the peripheral recognition device 53. The recognition area 53a indicates an area recognized by the sensors 53-1 and an obstruction existing in the area. Taking normal detection areas of FIG. 1 for examples, the recognition area 53a corresponds to the detection range 201 detected by the front camera and the preceding vehicle 212 existing in the detection range 201. Further, the recognition accuracy 53b is accuracy of recognition when the sensors 53-1 recognize the recognition area 53a. The recognition accuracy 53b is generated by the peripheral recognition device 53 which is the computer.

The action decision device 60 decides the action of the automobile 70 based on various information. The action selection device 10 outputs to the action decision device 60, information on the action of the automobile 70 that is executable, whether or not evacuation of the automobile 70 is necessary, and an evacuation method of the automobile 70.

*** Description of Operation ***

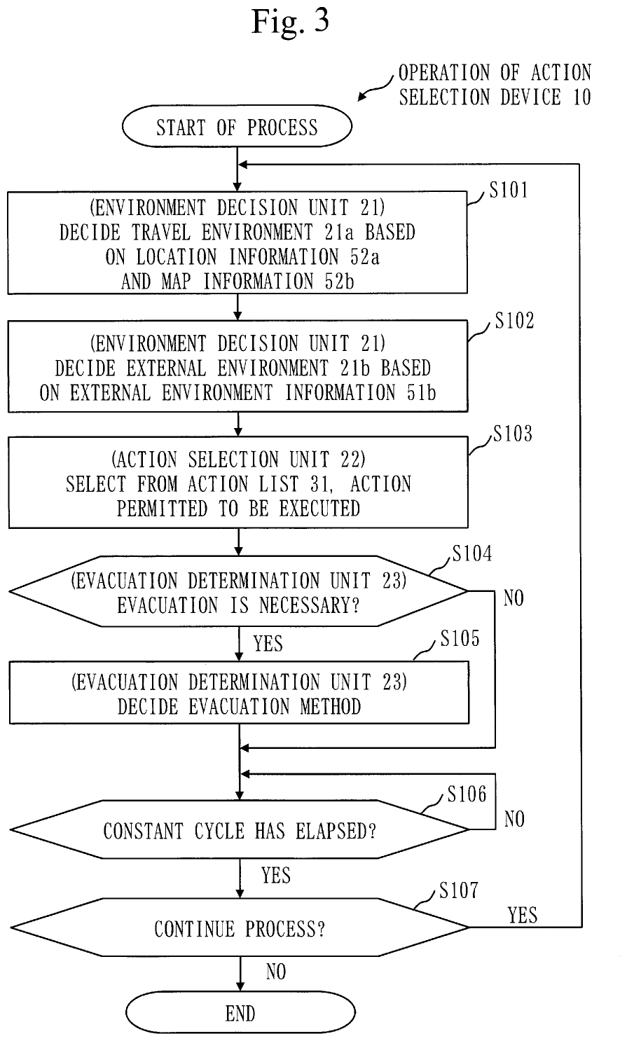

With reference to FIGS. 3 to 11, operation of the action selection device 10 will be described.

FIG. 3 is a flowchart explaining the operation of the action selection device 10. Description in parenthesis in FIG. 3 indicates a subject of the operation.

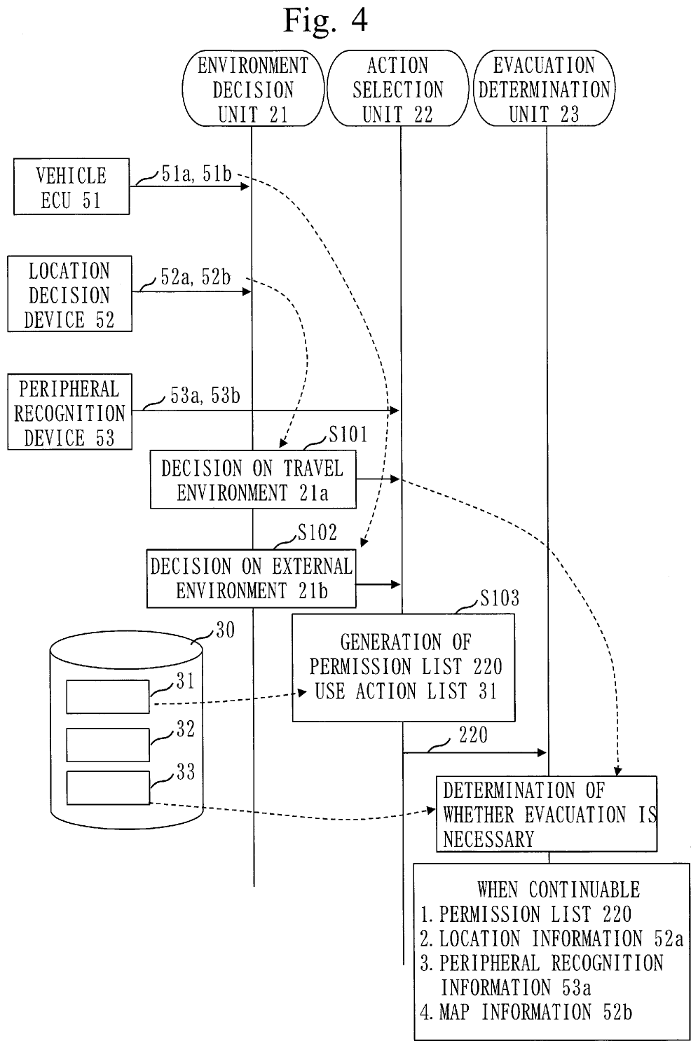

FIG. 4 is a sequence diagram explaining the operation of the action selection device 10. The operation of the action selection device 10 corresponds to the action selection method. Also, the operation of the action selection device 10 corresponds to a process of the action selection program or a circuit configuration of an action selection circuit.

With reference to FIGS. 3 and 4, the operation of the action selection device 10 will be described.

<Step S101: Decision on Travel Environment>

It is premised that the automobile 70 is performing the autonomous operation. The environment decision unit 21 decides the travel environment 21a. The travel environment 21a affects the recognition area 31a and the recognition accuracy 31b which are necessary to determine whether to permit or prohibit the actions in the action list 31. The travel environment 21a also affects the evacuation condition information 33. The environment decision unit 21 decides the travel environment 21a based on the location information 52a of the automobile 70 acquired from the location decision device 52 and also based on the map information 52b acquired from the location decision device 52.

The travel environment 21a is a road type such as a highway, a general road, or a community road.

When the automobile 70 travels on the highway, the automobile 70 needs to recognize another vehicle that cuts in front of the automobile 70 from an adjacent lane. Therefore, on the such highway, the adjacent lane is also included in the recognition area 53a needed to be recognized. On the other hand, when the automobile 70 travels on a community road where no adjacent lane exists, the recognition of the adjacent lane is unnecessary. Also, the minimum action required for the autonomous operation differs depending on the travel environment. Therefore, the travel environment affects evacuation determination. On the community road without the adjacent lane, it is sufficient if the automobile 70 can go straight, go straight at a crossroad, and turn left or right at a crossroad. However, when traveling on the highway, the automobile 70 needs to execute many actions.

<Step S102: Decision on External Environment 21b>

The environment decision unit 21 decides the external environment 21b that affects a motion characteristic of the vehicle. The environment decision unit 21 decides the external environment 21b based on the external environment information 51b acquired from the vehicle ECU 51. The external environment 21b includes environments such as weather, illuminance, a wind direction, and wind speed. An example of the external environment 21b that affects the motion characteristic of the vehicle is a road surface condition. In a case of the road surface condition where a road surface is wet due to rainfall, a stop distance of the automobile 70 increases as compared to a condition where the road surface is dry.

<Step S103: Selection of Action Permitted to be Executed>

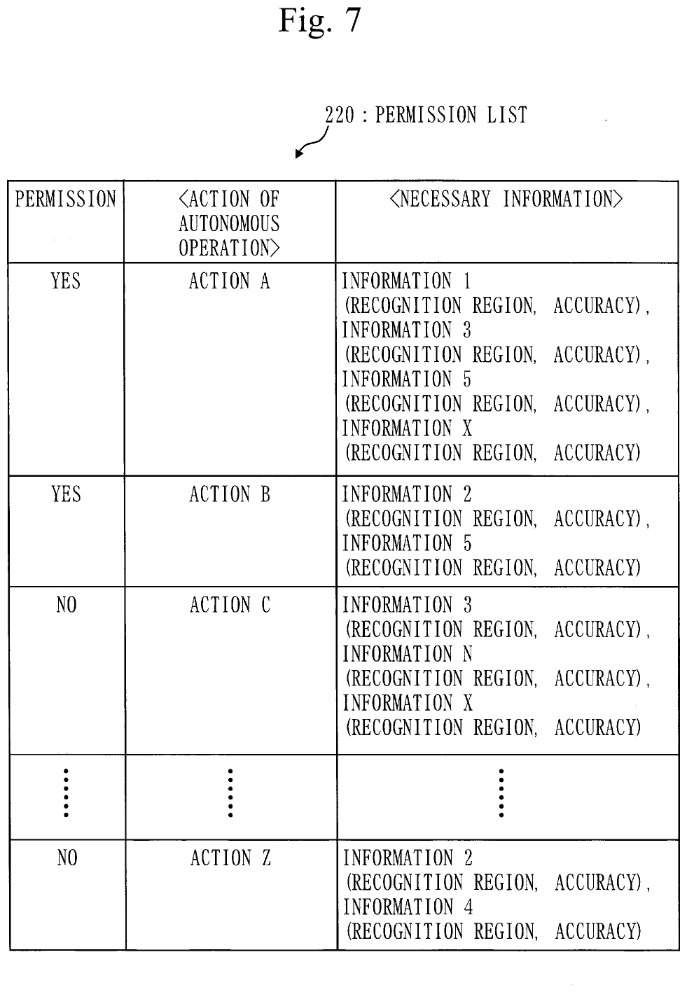

FIG. 7 illustrates a permission list 220.

The action selection unit 22 acquires the action list 31 from the memory 30. The action selection unit 22 is an action group information acquisition unit 92. The action selection unit 22 generates the permission list 220 from the action list 31. The action selection unit 22 determines whether to permit the execution or prohibit the execution for each action in the action list 31. The action selection unit 22 selects an action permitted to be executed.

The permission list 220 consists of the action selected by the action selection unit 22 among a plurality of actions listed in the action list 31. In the permission list 220 of FIG. 7, selected actions are permitted actions. In the permission list 220 of FIG. 7, the actions of YES in a permission column are the permitted actions, that is, the selected actions. The action selection unit 22 generates the permission list 220 based on the travel environment 21a decided in step S101, the external environment 21b decided in step S102, the recognition area 53a and the recognition accuracy 53b acquired from the peripheral recognition device 53, and the action list 31 and the environment correction information 32 stored in the memory 30.

Further, in the permission list 220, the action may be permitted with restriction. For example, for an action listed in the action list 31, the action selection unit 22 permits the action under a condition that an upper limit of travel speed is limited to 30 km/h.

<Step S104: Determination of Whether or not Evacuation is Necessary>

The evacuation determination unit 23 determines based on the travel environment 21a decided in step S101, the permission list 220 generated in step S103, and the evacuation condition information 33 stored in the memory 30, whether or not to continue the autonomous operation. The evacuation is unnecessary when continuing the autonomous operation, and the evacuation is necessary when stopping the autonomous operation. When the evacuation determination unit 23 determines that the evacuation is necessary, the process proceeds to step S105. When the evacuation determination unit 23 determines that the evacuation is unnecessary, the process proceeds to step S106. FIG. 11 illustrates the evacuation condition information 33. As illustrated in FIG. 11, the evacuation condition information 33 is a list on which a plurality of actions necessary for continuing the autonomous operation of the automobile 70 are listed for each vehicle travel environment 98 being the road type.

The evacuation condition information 33 is evacuation determination information 102. As illustrated in FIG. 11, in the evacuation condition information 33, the vehicle travel environment 98 is associated with one or more actions. When the vehicle travel environment 98 is a highway main line, the vehicle travel environment 98 is associated with an action A, an action E . . . and an action H. When the vehicle travel environment 98 is a general road (two lanes on each side), the vehicle travel environment 98 is associated with an action B, the action E . . . and an action K. When the vehicle travel environment 98 is a general road (one lane on each side), the vehicle travel environment 98 is associated with an action F, an action J . . . and an action P. When the vehicle travel environment 98 is a community road, the vehicle travel environment 98 is associated with an action C, the action K . . . and an action R. By referring to the evacuation condition information 33, the evacuation determination unit 23 determines whether or not all of the action associated with vehicle travel environment are included in the action selected by the action selection unit 22, the vehicle travel environment being indicated by the travel environment 21a which is decided by the environment decision unit 21. Specifically, when the travel environment 21a decided by the environment decision unit 21 is the highway main line, the evacuation determination unit 23 determines whether or not the action A, the action E . . . and the action H are included in the actions selected by the action selection unit 22. When all of “the action A, the action E . . . and the action H” are included in the actions selected by the action selection unit 22, the evacuation determination unit 23 determines that the evacuation is unnecessary, that is, the autonomous operation of the automobile 70 is possible to continue. On the other hand, when even any one of “the action A, the action E . . . and the action H” is not included in the actions selected by the action selection unit 22, the evacuation determination unit 23 determines that the evacuation of the automobile 70 is necessary.

<Step S105: Decision on Evacuation Method>

When it is determined in step S104 that the evacuation is necessary, the evacuation determination unit 23 decides a safe evacuation method based on the travel environment 21a decided in step S101 and the permission list 220 obtained in step S103. If an execution of an action of changing a lane to a left lane is not selected in the permission list 220, the automobile 70 cannot move to a road shoulder. Therefore, the evacuation determination unit 23 decides an evacuation action in which the automobile 70 slowly decelerates and stops in a lane in which the automobile 70 is currently traveling.

<Step S106: Elapse of Constant Cycle>

The recognition area 53a and the recognition accuracy 53b calculated and output by the peripheral recognition device 53 change along with time. The actions in the action list 31 depend on the recognition area 53a and the recognition accuracy 53b. Therefore, the permission list 220 needs to be updated in a constant cycle. Therefore, in step S106, elapse of the constant cycle is awaited.

<Step S107: Process Continuation Determination>

In step S107, the action selection device 10 checks intention of a driver whether to continue the autonomous operation or stop the autonomous operation. Specifically, the action selection device 10 displays on a display device that the action selection device 10 has but not illustrated, a selection request to request selection of continuation of the autonomous operation or stop of the autonomous operation. If it is the continuation, the process proceeds to step S101, and if it is the stop, the process ends.

After that, when the evacuation determination unit 23 determines that it is possible to continue the autonomous operation, the action decision device 60 decides the action of the automobile 70 based on information such as the permission list 220, the location information 52a, the map information 52b, and sensor recognition accuracy 97. The action decision device 60 autonomously drives the automobile 70 according to the decided action.

When executing each action included in the permission list 220, the action decision device 60 needs to confirm based on the sensor recognition accuracy 97, that no obstruction exists in the recognition area 53a required by each action.

On the other hand, when it is determined by the evacuation determination unit 23, that the evacuation is necessary, the action decision device 60 decides the evacuation action of the automobile 70 according to an evacuation route decided by the evacuation determination unit 23. The action decision device 60 controls the automobile 70 according to the decided evacuation action.

FIG. 5 illustrates the action list 31.

FIG. 6 illustrates a specific example of the action list 31. The action list 31 will be described with reference to FIGS. 5 and 6. The action list 31 is a list that defines relation between actions that can be taken in the autonomous operation and information necessary for executing each action. The information necessary for executing each action includes the recognition area 31a and the recognition accuracy 31b. In the action list 31 of FIG. 5, information 1, information 3, information 5, and information X are necessary for executing the action A.

In addition, granularity of the action can be arbitrarily decided. For example, it is also possible to define “going straight in a current travel lane at a speed of 60 km/h in a travel environment where there is no cut-in from an adjacent lane and there is no intersection”. It is also possible to define “traveling on a left lane of an intersection where there exist two lanes on each side, thus, four lanes in total and a traffic signal, and going straight on the intersection”. In this way, it is possible to finely define the granularity of the action. On the other hand, it is possible to roughly define the action as “traveling on a highway main line”.

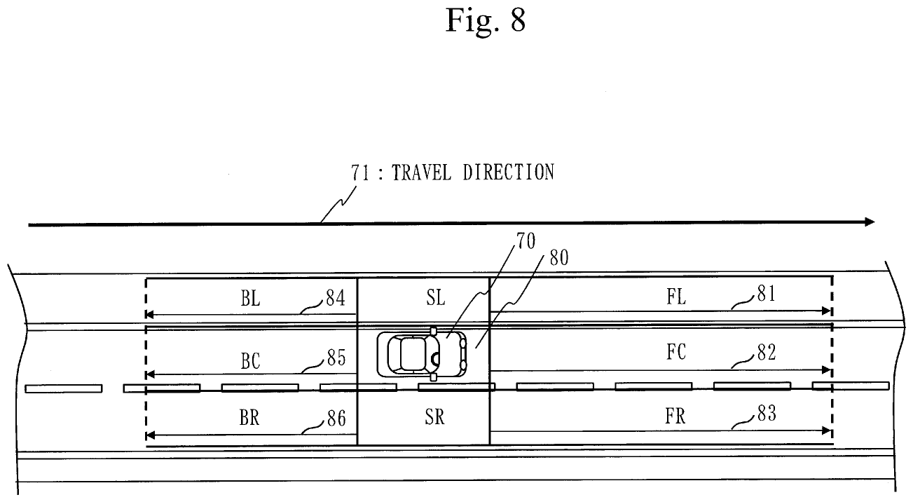

FIG. 8 illustrates a method for dividing the area on a periphery of the automobile 70. Although in FIG. 8, the area on the periphery of the automobile 70 is defined as eight divisions, the area on the periphery of the automobile 70 can be arbitrarily divided and defined.

FIG. 8 will be described.

In FIG. 8, for the automobile 70 traveling on a road with three lanes, the area on the periphery of the automobile 70 is divided into eight. With respect to an area 80 in which the automobile 70 exists, a travel direction 71 of the automobile 70 is a front direction, and a direction opposite to the front direction is a rear direction. Areas on a left side in the front direction, on middle in the front direction, and on a right side in the front direction are respectively set as an FL area, an FC area, and an FR area. Left and right areas with respect to the area 80 are set as an SL area and an SR area. Areas behind the automobile 70 with respect to the area 80 are set as a BL area, a BC area, and a BR area. For the SL area and the SR area, sizes are decided. Each of six areas of the FL area, the FC area, the FR area, the BL area, the BC area, and the BR area has a same width as a width of each lane. But, a distance in the travel direction of each is not decided. That is, each distance of a distance 81, a distance 82, a distance 83, a distance 84, a distance 85, and a distance 86 is not decided. These distances are required by the recognition area 31a in information of the action list 31.

The action list 31 is action group information 91. In the action list 31, the recognition area 31a is associated with each action of a plurality of actions, the recognition area 31a being a requirement recognition area 94 indicating an area for which a recognition by the sensor is required. As will be explained with FIG. 6, each action in the action list 31 is associated with the recognition accuracy 31b together with the recognition area 31a that is the requirement recognition area 94, the recognition accuracy 31b being requirement accuracy 96 indicating recognition accuracy of the requirement recognition area 94 required for the sensor. Each of pieces of information illustrated in FIG. 5 has the recognition area 31a and the recognition accuracy 31b. The recognition area 31a corresponds to a recognition area 53a, and the recognition accuracy 31b corresponds to a recognition accuracy 53b.

FIG. 6 will be described. FIG. 6 illustrates the information 3, the information N, and the information X necessary for determining whether or not to select the action, that is, whether to permit or prohibit the action. FIG. 6 illustrates a relationship between the recognition area 31a and the recognition accuracy 31b necessary when “going straight in a current lane on a straight road with no intersection”. The action list 31 in FIG. 6 indicates that the information 3, the information N, and the information X are necessary for the action C.

(1) The information 3 indicates that a range of XX m is necessary in the FC area, as the recognition area 31a. That is, the distance 82 is the XX m. The XX m corresponds to <restrictions> described later. The information 3 indicates that the recognition accuracy 31b required when the sensors 53-1 recognize the FC area is 99%.
(2) The information N indicates that the range of 20 m is necessary in the FR area, as the recognition area 31a. That is, the distance 83 is the 20 m. Further, the information N indicates that the recognition accuracy 31b required when the sensors 53-1 recognize the FR area is 97%.
(3) The information X indicates that an entire area of the SR area needs to be recognized as the recognition area 31a. Further, the information X indicates that the recognition accuracy 31b required when the sensors 53-1 recognizes the SR area is 98%.

In the information 3 of FIG. 6, travel speed is limited according to the range of XX m of the FC area. In <restrictions> in FIG. 6, if the range of XX m of the FC area is 100 m, a limit of a speed limit of 100 km/h or less is applied. If the range of XX m of the FC area is 70 m, a limit of a speed limit of 80 km/h or less is applied. If the range of XX m of the FC area is 40 m, a limit of a speed limit of 60 km/h or less is imposed.

The process of the action selection unit 22 which is a selection unit 93 will be described. The action selection unit 22 acquires the recognition area 53a which is a sensor recognition area 95 indicating the area recognized by the sensors 53-1. Also, the action selection unit 22 selects from the action list 31, an action associated with the recognition area 31a included in the recognition area 53a.

Further, the action selection unit 22 acquires from the peripheral recognition device 53, together with the recognition area 53a, the recognition accuracy 53b that is sensor recognition accuracy indicating the recognition accuracy of the sensor, the sensor recognition accuracy being accuracy when the sensor recognizes the recognition area 53a. The action selection unit 22 selects from the action list 31, an action for which the recognition area 31a is included in the recognition area 53a, and the recognition accuracy 31b is satisfied by the recognition accuracy 53b, the recognition area 31a being the requirement recognition area 94, the recognition area 53a being the sensor recognition area 95, the recognition accuracy 31b being the requirement accuracy 96, the recognition accuracy 53b being the sensor recognition accuracy 97. The action selection unit 22 determines whether or not the recognition area 31a and the recognition accuracy 31b defined for each action defined in the action list 31 are satisfied, based on the recognition area 53a and the recognition accuracy 53b which are acquired from the peripheral recognition device 53. When the recognition area 53a satisfies the recognition area 31a of the action and the recognition accuracy 53b satisfies the recognition accuracy 31b of the action, the action selection unit 22 permits the action. When both the recognition area 31a and the recognition accuracy 31b are not satisfied, the action selection unit 22 prohibits the action. A fact that the action selection unit 22 permits the action is that the action selection unit 22 selects the action.

Further, the action selection unit 22 can correct the recognition area 31a and the recognition accuracy 31b defined in the action list 31 by using the environment correction information 32. The action selection unit 22 may correct both the recognition area 31a and the recognition accuracy 31b, or may correct one of them.

FIG. 9 illustrates an example of correction information based on the road surface condition among the environment correction information 32. FIG. 9 illustrates a relationship between a road surface friction coefficient and an increase/decrease rate of a stop distance. Generally, on a road in a dry state, a friction coefficient is 0.8. In FIG. 9, the friction coefficient of 0.8 is regarded as a standard value, and a correction rate is 1.0. In a case of rainfall, the friction coefficient is 0.5. Therefore, the action selection unit 22 corrects the recognition area 31a as follows. When the recognition area 31a in front is defined as 50 m in the action list 31, the action selection unit 22 corrects 50 m to be 50 m*1.6=80 m by using a stop distance correction value of 1.6, in order to avoid a collision with a front obstruction. By the correction, the recognition area 31a in front is corrected from 50 m to 80 m. The environment correction information 32 includes in addition to the correction information based on the road surface condition, information that affects the motion characteristic of the vehicle, such as a wind direction, wind speed, vehicle weight, and a road gradient.

The environment correction information 32 is correction information 100 in which the vehicle travel environment 98 and area correction data 99 are associated with each other, the area correction data 99 being used to correct the recognition area 31a that is the requirement recognition area 94. The vehicle travel environment 98 is the road type in the same way as the travel environment 21a. In FIG. 9, each set of the road surface friction coefficient and a stop distance correction value is the area correction data 99. In FIG. 9, the vehicle travel environment 98 and corresponding area correction data 99 are associated with each other. The action selection unit 22 acquires the area correction data 99 associated with the vehicle travel environment 98 indicated by the travel environment 21a decided by the environment decision unit 21. In this example, the travel environment 21a is the highway. In an above example, a set of the road surface friction coefficient of 0.5 and the stop distance correction value of 1.6 has been acquired as the area correction data 99. The action selection unit 22 corrects by using the area correction data 99 acquired, the recognition area 31a which is the requirement recognition area 94. Then, after the correction, the action selection unit 22 selects the action from the action list 31.

FIG. 10 illustrates environment correction information 32-1 used for correction of the recognition accuracy 31b among the environment correction information 32. In the environment correction information 32-1 in FIG. 10, the vehicle travel environment 98 and corresponding accuracy correction data 103 are associated with each other. In the environment correction information 32-1, each of pieces of the accuracy correction data 103 is a set of a time range and accuracy. The accuracy of the environment correction information 32-1 indicates accuracy of the camera. In the time range from 9:00 to 15:00, the accuracy is required to be accuracy as high as 99%. On the other hand, in the time range from 24:00 to 09:00, required accuracy is lower than that in the time range from 9:00 to 15:00. The action selection unit 22 acquires from the environment correction information 32-1, the accuracy correction data 103 associated with the vehicle travel environment 98 indicated by the travel environment 21a decided by the environment decision unit 21. In this example, the travel environment 21a is the general road. The action selection unit 22 has a clock, and with the clock, the action selection unit 22 knows that it is 10:00. Therefore, the action selection unit 22 acquires from the environment correction information 32-1, the accuracy of 99% in the time range from 9:00 to 15:00 as the accuracy correction data 103. The action selection unit 22 corrects by using the accuracy of 99% acquired, the recognition accuracy 31b which is the requirement accuracy 96. Then, after the correction, the action selection unit 22 selects the action from the action list 31.

*** Effect of First Embodiment***

(1) The action selection device 10 according to the first embodiment selects whether or not the action is executable, after considering the recognition area 53a and the recognition accuracy 53b at a time of determining whether or not to continue the autonomous operation. Further, after selecting whether or not the action is executable, the action selection device 10 according to the first embodiment adopts the action to be actually executed. Therefore, it is possible to prevent an adoption of a risky action caused by erroneous detection of obstruction and an absence of detection of an obstruction.
(2) Further, when at least any of the recognition area 53a and the recognition accuracy 53b has changed, the action selection device 10 detects that the automobile 70 cannot safely continue the autonomous operation, and also can safely evacuate the automobile 70.

### REFERENCE SIGNS LIST

10: action selection device, 20: processor, 21: environment decision unit, 21a: travel environment, 21b: external environment, 22: action selection unit, 220: permission list, 23: evacuation determination unit, 30: memory, 31: action list, 31a: recognition area, 31b: recognition accuracy, 32, 32-1: environment correction information, 33: evacuation condition information, 40: input/output interface device, 51: vehicle ECU, 51a: vehicle information, 51b: external environment information, 52: location decision device, 52a: location information, 52b: map information, 53: peripheral recognition device, 53-1: sensors, 53a: recognition area, 53b: recognition accuracy, 60: action decision device, 70: automobile, 71: travel direction, 80: area, 81, 82, 83, 84, 85, 86: distance, 91: action group information, 92: action group information acquisition unit, 93: selection unit, 94: requirement recognition area, 95: sensor recognition area, 96: requirement accuracy, 97: sensor recognition accuracy, 98: vehicle travel environment, 99: area correction data, 100: correction information, 102: evacuation determination information, 103: accuracy correction data.

1. An action selection device comprising:
processing circuitry:
to acquire action group information in which a requirement recognition area is associated with each action of a plurality of actions that a moving body capable of autonomous operation takes, the requirement recognition area indicating a range of an area for which recognition by a sensor is necessary; and
to acquire a sensor recognition area indicating an area recognized by the sensor, the sensor recognition area being an area that a peripheral recognition device outputs, and select from the action group information, an action associated with the requirement recognition area included in the sensor recognition area.

2. The action selection device according to claim 1,
wherein each of the actions in the action group information is associated with requirement accuracy indicating recognition accuracy of the requirement recognition area required for the sensor, together with the requirement recognition area; and
wherein the processing circuitry acquires sensor recognition accuracy indicating recognition accuracy of the sensor, together with the sensor recognition area, the sensor recognition accuracy being accuracy when the sensor recognizes the sensor recognition area, and selects from the action group information, the action for which the requirement recognition area is included in the sensor recognition area and the requirement accuracy is satisfied by the sensor recognition accuracy.

3. The action selection device according to claim 1,
wherein the action selection device being mounted on a vehicle,
the action selection device further comprising
the processing circuitry to decide a travel environment where the vehicle is traveling,
wherein the processing circuitry acquires from correction information in which a vehicle travel environment and area correction data used for a correction of the requirement recognition area are associated, the area correction data associated with the vehicle travel environment indicated by the travel environment decided, corrects the requirement recognition area by using the area correction data acquired, and after the correction, selects the action from the action group information.

4. The action selection device according to claim 2,
wherein the action selection device being mounted on a vehicle,
the action selection device further comprising
the processing circuitry to decide a travel environment where the vehicle is traveling,
wherein the processing circuitry acquires from correction information in which a vehicle travel environment and area correction data used for a correction of the requirement recognition area are associated, the area correction data associated with the vehicle travel environment indicated by the travel environment decided, corrects the requirement recognition area by using the area correction data acquired, and after the correction, selects the action from the action group information.

5. The action selection device according to claim 2,
wherein the action selection device being mounted on a vehicle,
the action selection device further comprising
the processing circuitry to decide a travel environment where the vehicle is traveling,
wherein the processing circuitry acquires from correction information in which a vehicle travel environment and accuracy correction data used for a correction of the requirement accuracy are associated, the accuracy correction data associated with the vehicle travel environment indicated by the travel environment decided, corrects the requirement accuracy by using the accuracy correction data acquired, and after the correction, selects the action from the action group information.

6. The action selection device according to claim 1,
wherein the action selection device being mounted on a vehicle,
the action selection device further comprising:
the processing circuitry:
to decide a travel environment where the vehicle is traveling; and
to determine by referring to evacuation determination information in which a vehicle travel environment and one or more actions are associated with each other, whether or not all of the action associated with the vehicle travel environment indicated by the travel environment decided is included in the action selected, determine that evacuation of the vehicle is unnecessary in a case that all of the action is included in the action selected, and determine that the evacuation of the vehicle is necessary in a case other than the case that all of the action is included in the action selected.

7. The action selection device according to claim 2,
wherein the action selection device being mounted on a vehicle,
the action selection device further comprising:
the processing circuitry:
to decide a travel environment where the vehicle is traveling; and
to determine by referring to evacuation determination information in which a vehicle travel environment and one or more actions are associated with each other, whether or not all of the action associated with the vehicle travel environment indicated by the travel environment decided is included in the action selected, determine that evacuation of the vehicle is unnecessary in a case that all of the action is included in the action selected, and determine that the evacuation of the vehicle is necessary in a case other than the case that all of the action is included in the action selected.

8. A non-transitory computer readable medium storing an action selection program which causes a computer to execute:
a process of acquiring action group information in which a requirement recognition area is associated with each action of a plurality of actions that a moving body capable of autonomous operation takes, the requirement recognition area indicating a range of an area for which recognition by a sensor is necessary;
a process of acquiring a sensor recognition area indicating an area recognized by the sensor, the sensor recognition area being an area that a peripheral recognition device outputs; and
a process of selecting from the action group information, an action associated with the requirement recognition area included in the sensor recognition area.

9. An action selection method comprising:
acquiring action group information in which a requirement recognition area is associated with each action of a plurality of actions that a moving body capable of autonomous operation takes, the requirement recognition area indicating a range of an area for which recognition by a sensor is necessary;
acquiring a sensor recognition area indicating an area recognized by the sensor, the sensor recognition area being an area that a peripheral recognition device outputs; and
selecting from the action group information, an action associated with the requirement recognition area included in the sensor recognition area.
